(19) United States
(12) Patent Application Publication
(10) Pub. No.: US 2025/0270120 A1
(43) Pub. Date: Aug. 28, 2025

(54) PHOTOELECTROCHEMICAL DEVICE AND PURIFICATION METHOD FOR SEAWATER

(71) Applicant: BEIJING NORMAL UNIVERSITY AT ZHUHAI, Zhuhai City (CN)

(72) Inventors: Zihao WU, Zhuhai City (CN); Shengrui WANG, Zhuhai City (CN); Xinrui CAI, Zhuhai City (CN); Wenhui GAN, Zhuhai City (CN); Bo LIANG, Zhuhai City (CN)

(73) Assignee: BEIJING NORMAL UNIVERSITY AT ZHUHAI, Zhuhai City (CN)

(21) Appl. No.: 18/642,047

(22) Filed: Apr. 22, 2024

(30) Foreign Application Priority Data
Feb. 26, 2024 (CN) 202410211634.5

(51) Int. Cl. C02F 1/467; C02F 1/32; C02F 1/461; C02F 103/08

(52) U.S. Cl. CPC C02F 1/467; C02F 1/325; C02F 1/46109; C02F 2001/46133; C02F 2001/46152; C02F 2103/08; C02F 2201/3222; C02F 2201/4617

(57) ABSTRACT

A photoelectrochemical device and a purification method for seawater are provided and belong to the technical field of seawater purification. A photoelectrochemical device is provided, which includes a reactor assembly (1), an electrode assembly (2), and an ultraviolet lamp assembly (3); the reactor assembly (1) includes a reactor body and a reactor top cover; and the electrode assembly (2) and the ultraviolet lamp assembly (3) are fixed on the reactor top cover.

### CROSS-REFERENCE TO RELATED APPLICATION

This patent application claims the benefit and priority of Chinese Patent Application No. 2024102116345 filed with the China National Intellectual Property Administration on Feb. 26, 2024, the disclosure of which is incorporated by reference herein in its entirety as part of the present application.

### TECHNICAL FIELD

The present disclosure belongs to the technical field of seawater purification, and in particular, to a photoelectrochemical device and a purification method for seawater.

### BACKGROUND

In recent years, new pollutants have been frequently detected in water bodies. Due to their stability and bioaccumulation, the new pollutants have gradually attracted people's attention. The new pollutants come from people's life. With the development of science and technology, types of new pollutants continue to increase. Norfloxacin, ofloxacin, ciprofloxacin, and fluoroquinoline are widely used as commonly used antibiotics in marine aquaculture areas. Sunscreen agents such as benzophenone, camphor derivatives, and cinnamic acid would be left greatly in seawater of seaside bathing areas and have significant toxic effects on various marine organisms. These new pollutants enter drinking water at low concentrations through water circulation, so that the human health is ultimately affected. Therefore, treatment of the new pollutants has become a widely concerned issue.

At present, in a new-pollutant treatment technology, a UV/Chlorine system has received widespread attention due to its ability to produce RCS (Cl⁻, Cl₂⁻, ClO⁻, and the like) that is more selective than hydroxyl radicals. However, due to the continuous consumption of hypochlorous acid in a reaction process, the concentration of active substances decreases, making it impossible to continuously degrade the new pollutants. In addition, the transportation and purchase cost of the hypochlorous acid is high, which is not conducive to the practical application and development of the technology. An electrochemical anode chlorine production technology (EC/Cl⁻) can utilize Cl⁻ in a water body to produce chlorine and generate hydroxyl radicals, but its removal effect on some new pollutants is poor. Therefore, it is necessary to research and develop an economical, environmentally friendly, and widely applicable method that can continuously produce chlorine to achieve continuous degradation of the new pollutants and can also efficiently generate free radicals RCS.

### SUMMARY

The present disclosure aims to provide a photoelectrochemical device and a purification method for seawater. The electrochemical device provided by the present disclosure can achieve continuous degradation of pollutants, has high degradation efficiency, and is economical and environmentally friendly.

In order to achieve the above objective, the present disclosure provides the following technical solutions:

The present disclosure provides a photoelectrochemical device, including a reactor assembly 1, an electrode assembly 2, and an ultraviolet lamp assembly 3, wherein the reactor assembly 1 includes a reactor body and a reactor top cover; and
the electrode assembly 2 and the ultraviolet lamp assembly 3 are fixed on the reactor top cover.

Preferably, the reactor body is cylindrical double-layer glass; an outer sidewall of the reactor body is provided with a circulating water bath inlet 7 and a circulating water bath outlet 7;
the photoelectrochemical device further includes a circulating water bath assembly 6; the circulating water bath assembly 6 includes a circulating water pump 22 and a rubber pipe 23; and
the circulating water pump 22 is connected to the circulating water bath inlet 7 and a circulating water bath outlet 7 through the rubber pipes 23.

Preferably, the reactor top cover is made of polytetrachloroethylene; the reactor top cover is provided with a first through hole 8, a second through hole 9, and a third through hole 10;
the first through hole 8 is configured to fix the ultraviolet lamp assembly 3; the second through hole 9 is configured to fix the electrode assembly 2; and the third through hole 10 is configured for sampling and detection.

Preferably, the electrode assembly 2 includes PEEK electrode clamps 11, a ruthenium iridium titanium electrode sheet 12, a stainless steel plate 13, wires 14, and a direct current power supply 15; and
the ruthenium iridium titanium electrode sheet 12 and the stainless steel plate 13 are connected to the direct current power supply 15 through the PEEK electrode clamps 11 and the wires 14 in sequence, respectively.

Preferably, the ultraviolet lamp assembly 3 includes a light-emitting diode lamp 16 and a quartz glass protective lampshade 17.

Preferably, the photoelectrochemical device further includes a heat dissipation assembly 4; the heat dissipation assembly 4 includes an air blower 18 and a ventilation pipe 19; and the ventilation pipe 19 is arranged in the quartz glass protective lampshade 17.

Preferably, the photoelectrochemical device further includes a magnetic stirring assembly 5; the magnetic stirring assembly 5 includes a rotor 20 and a magnetic stirrer 21; and the reactor body is arranged on the magnetic stirrer 21.

The present disclosure further provides a purification method for seawater, which is implemented by the photoelectrochemical device of the above technical solution. The method includes the following steps:
feeding seawater to be purified into the reactor assembly 1, and purifying the water to be purified under the combined action of electrolysis and ultraviolet irradiation by using the electrode assembly 2 and ultraviolet lamp assembly 3.

Preferably, a distance between the ruthenium iridium titanium electrode sheet 12 and the stainless steel plate 13 in the electrode assembly 2 is 3 to 6 cm;
a voltage of the electrolysis is 2.46 to 2.69 V, and a current density is 1 to 5 mA/cm²; and
a wavelength of ultraviolet light used for the ultraviolet irradiation is 285 nm.

Preferably, the purification is carried out under a stirring condition, and a rotation speed of stirring is 400 rpm; and a temperature of the purification is 15 to 30°° C.

The present disclosure provides a photoelectrochemical device, including a reactor assembly 1, an electrode assembly 2, and an ultraviolet lamp assembly 3; the reactor assembly 1 includes a reactor body and a reactor top cover; and the electrode assembly 2 and the ultraviolet lamp assembly 3 are fixed on the reactor top cover. Some embodiments achieve degradation of new pollutants in a water body through the combination of ultraviolet light and an electrochemical advanced oxidation technology. Compared with an electrochemical technology and a photolysis technology, some embodiments have the advantages of low cost, economy, environmental protection, and high degradation efficiency. Some embodiments can adjust a reactor volume, an electrolysis condition, and an electrode spacing and size according to a water quality condition and an actual situation, and has a wide application prospect.

### BRIEF DESCRIPTION OF THE DRAWINGS

FIG. 1 is a schematic structural diagram of a photoelectrochemical device provided according to the present disclosure;

FIG. 2 is a front view of an electrode assembly 2 in the present disclosure;

FIG. 3 is a front view of an ultraviolet lamp assembly 3 and a heat dissipation assembly 4 in the present disclosure;

FIG. 4 is a front view of a reactor assembly 1, a magnetic stirring assembly 5, and a circulating water bath assembly 6 in the present disclosure;

FIG. 5 is a top view of a reactor top cover in the present disclosure;

FIG. 6 is a schematic diagram of a reaction principle of seawater purification in the present disclosure; and

FIG. 7 is an effect diagram of reaction and degradation of an antibiotic (enrofloxacin) in seawater in the present disclosure.

In the drawings: 1 reactor assembly; 2 electrode assembly; 3 ultraviolet lamp assembly; 4 heat dissipation assembly; 5 magnetic stirring assembly; 6 circulating water bath assembly; 7 water bath inlet/outlet; 8 first through hole; 9 second through hole; 10 third through hole; 11 PEEK electrode clamp; 12 ruthenium iridium titanium electrode sheet; 13 stainless steel plate; 14 wire; 15 direct current power supply; 16 LED lamp; 17 quartz glass protective lampshade; 18 air blower; 19 ventilation pipe; 20 rotor; 21 magnetic stirrer; 22 circulating water pump; and 23 rubber pipe.

### DETAILED DESCRIPTION OF THE EMBODIMENTS

The present disclosure provides a photoelectrochemical device, including a reactor assembly 1, an electrode assembly 2, and an ultraviolet lamp assembly 3;
the reactor assembly 1 includes a reactor body and a reactor top cover; and
the electrode assembly 2 and the ultraviolet lamp assembly 3 are fixed on the reactor top cover.

In the present disclosure, the reactor body is preferably cylindrical double-layer glass; and an outer sidewall of the reactor body is provided with a circulating water bath inlet 7 and a circulating water bath outlet 7. In the present disclosure, the photoelectrochemical device further preferably includes a circulating water bath assembly 6; the circulating water bath assembly 6 preferably includes a circulating water pump 22 and rubber pipes 23; and the circulating water pump 22 is connected to the circulating water bath inlet 7 and the circulating water bath outlet 7 through the rubber pipes 23. In the present disclosure, the circulating water pump 22 is connected to the circulating water bath inlet 7 and the circulating water bath outlet 7 on two sides of the reactor body through the rubber pipes 23, so that a temperature is constant in a reaction process through water bath heating.

In the present disclosure, the reactor top cover is preferably made of polytetrachloroethylene; the reactor top cover is preferably provided with a first through hole 8, a second through hole 9, and a third through hole 10; the first through hole 8 is configured to fix the ultraviolet lamp assembly 3; the second through hole 9 is configured to fix the electrode assembly 2; and the third through hole 10 is configured for sampling and detection.

In the present disclosure, the electrode assembly 2 preferably includes PEEK electrode clamps 11, a ruthenium iridium titanium electrode sheet 12, a stainless steel plate 13, wires 14, and a direct current power supply 15; and the ruthenium iridium titanium electrode sheet 12 and the stainless steel plate 13 are preferably connected to the direct current power supply 15 through the PEEK electrode clamps 11 and the wires 14 in sequence, respectively. In the present disclosure, a thickness of each of the ruthenium iridium titanium electrode sheet 12 and the stainless steel plate 13 is preferred to be 1 mm, and a size of each of the ruthenium iridium titanium electrode sheet 12 and the stainless steel plate 13 is preferred to be 1×4 cm.

In the present disclosure, the ruthenium iridium titanium electrode sheet 12 and the stainless steel plate 13 serve as a positive electrode and a negative electrode of the device, respectively, and sizes of polar plates can be adjusted according to an actual application situation. The ruthenium iridium titanium electrode sheet 12 is a DSA electrode. Compared with a commonly used inert electrode (such as BDD), this electrode can directly oxidize chloride ions to Cl₂ on the surface, and generate HClO/OCl⁻ in an ion diffusion layer on the surface of the positive electrode and reaction solution. This electrode has high catalytic activity, good electrochemical stability and low electrolysis energy consumption, can effectively save electric energy, and has higher chlorine production efficiency. In the present disclosure, a voltage of the direct current power supply 15 is preferably 12 V. In the present disclosure, the ruthenium iridium titanium electrode sheet 12 and the stainless steel plate 13 need to be cleaned and regularly maintained after use so as to ensure the chlorine production efficiency.

In the present disclosure, the ultraviolet lamp assembly 3 preferably includes an LED lamp 16 and a quartz glass protective lampshade 17. In the present disclosure, the quartz glass protective lampshade 17 has good light transmittance.

In the present disclosure, the photoelectrochemical device further preferably includes a heat dissipation assembly 4; the heat dissipation assembly 4 preferably includes an air blower 18 and a ventilation pipe 19; and the ventilation pipe 19 is preferably arranged in the quartz glass protective lampshade 17. In the present disclosure, the air blower 18 transports an air flow into the ultraviolet lamp assembly 3 through the ventilation pipe 19 to prevent an extremely high temperature of an LED lamp from affecting the performance.

Preferably, the photoelectrochemical device further includes a magnetic stirring assembly 5; the magnetic stirring assembly 5 preferably includes a rotor 20 and a magnetic stirrer 21; and the reactor body is preferably arranged on the magnetic stirrer 21. In the present disclosure, the rotor 20 rotates to drive a water body to flow so as to ensure that the water body in a reactor is a homogeneous system.

The present disclosure further provides a purification method for seawater, which is implemented by the photoelectrochemical device of the above technical solution. The method includes the following steps:
feeding seawater to be purified into the reactor assembly 1, and purifying the seawater to be purified under the combined action of electrolysis and ultraviolet irradiation by using the electrode assembly 2 and ultraviolet lamp assembly 3.

In the present disclosure, a distance between the ruthenium iridium titanium electrode sheet 12 and the stainless steel plate 13 in the electrode assembly 2 is preferably 3 to 6 cm. In the present disclosure, a voltage of the electrolysis is preferably 2.46 to 2.69 V, and a current density is preferably 1 to 5 mA/cm².

In the present disclosure, a wavelength of ultraviolet light used for the ultraviolet irradiation is preferably 285 nm. In the present disclosure, the ultraviolet light with the wavelength of 285 nm is used for irradiation. The degradation rate of the ultraviolet light with the wavelength of 285 nm for most pollutants is greater than the degradation rates of commonly used ultraviolet light with the wavelengths of 265 nm and 254 nm, and the molar absorption coefficient of chlorine is the largest. In the purification process of the present disclosure, it is preferred to wrap the reactor body with a tin foil to prevent the LED lamp from irradiating the human body and improve the light efficiency.

In the present disclosure, the purification is carried out under a stirring condition, and a rotation speed of stirring is preferably 400 rpm. In the present disclosure, a temperature of the purification is preferably 15 to 30° C., further preferably 21±2° C.

In the present disclosure, a specific purification process is preferably as follows: The ultraviolet lamp assembly 3 is mounted on the first through hole 8 of the reactor top cover; the electrode assembly 2 is mounted on the second through hole 9; and the third through hole 10 is sealed with a sealing bolt. The reactor assembly 1 is arranged on the magnetic stirrer 21, and the rotor 20 is placed. The seawater to be treated is added into the reactor body, and the reactor top cover is closed. The speed is adjusted to make the rotor 20 rotate slowly at a uniform speed. The ventilation pipe 19 connected to the air blower 18 is led into the ultraviolet lamp assembly 3 to uniformly supply air. The rubber pipe 23 is connected to the circulating water bath inlet 7 and the circulating water bath outlet 7 on the outer sidewall of the reactor body. The circulating water pump 22 is turned on; a temperature is set; and preheating is carried out for 20 min before the reaction begins. The reactor body is wrapped with the tin foil to prevent the LED lamp from irradiating the human body and improve the light efficiency. The 12V direct current power supply 15 is connected to the two electrode clamps 11 through the wires 14. The distance between the ruthenium iridium titanium electrode plate 12 and the stainless steel plate 13 is adjusted. The current density is set. After the temperature is controlled to be constant, the direct current power supply 15 and the LED lamp 16 are turned on to start the reaction. During the reaction, the third through hole 10 can be opened according to set time for sampling and detection.

In the present disclosure, a mechanism of the purification is preferably as follows: chloride ions and hydroxy radicals in the water body generate a small number of Cl₂, Cl⁻, and ⁻OH under the oxidation action of the positive electrode, and Cl2 further generates HClO and OCl⁻. Under an alkaline condition, the ultraviolet light promotes HClO and OCl⁻ to generate ClO⁻; Cl⁻ is transformed into Cl2⁻; and the hydroxy radicals are transformed into ⁻OH. Furthermore, H₂O/OH⁻ in the water body generates O₂ under the action of the negative electrode, and ¹O₂ is generated under the catalysis of the ultraviolet light. Free chlorine (HClO, OCl⁻, Cl₂) and singlet oxygen, ⁻OH, Cl⁻, ClO⁻, Cl₂⁻, and other substances generated in the process of the method further react with pollutants in the water body to achieve degradation.

In order to further illustrate the present disclosure, the electrochemical device and the purification method for seawater provided by the present disclosure will be described in detail in conjunction with the accompanying drawings and embodiments, but they cannot be understood as limiting the protection scope of the present disclosure.

### Embodiment 1

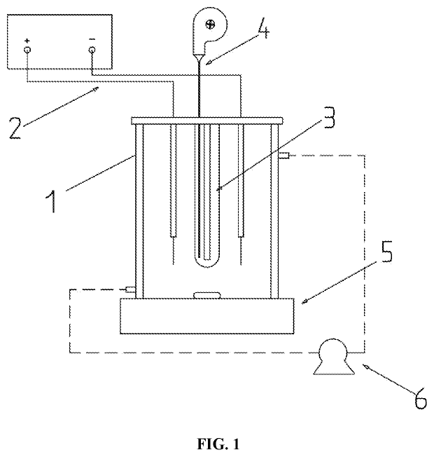

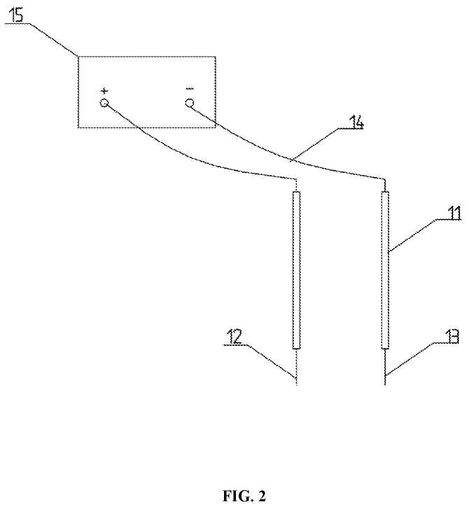

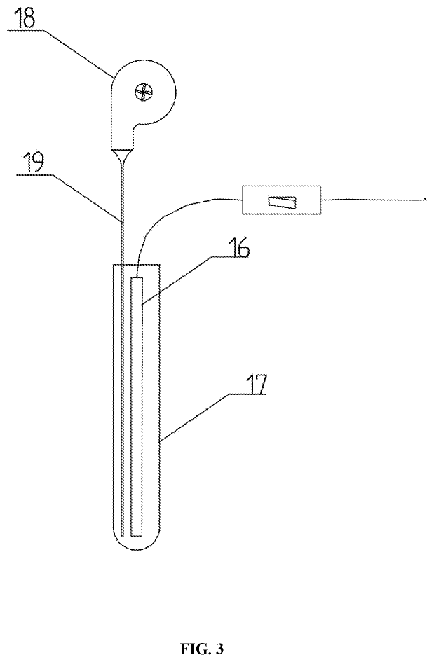

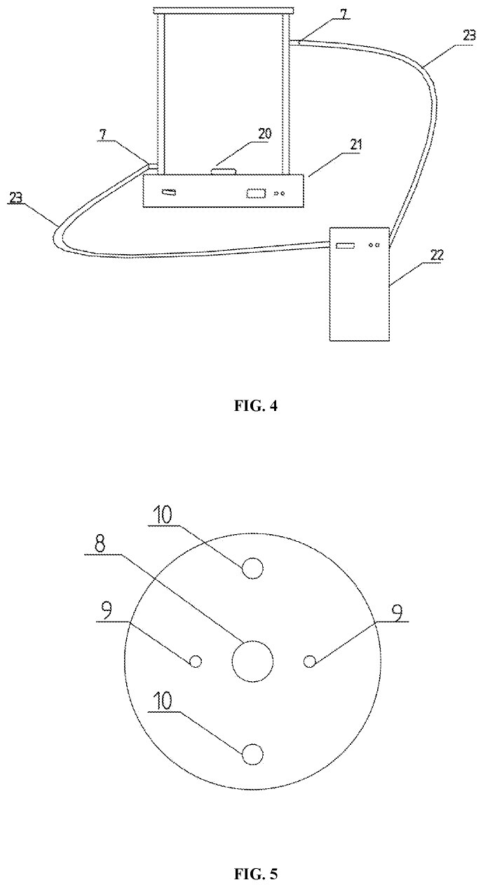

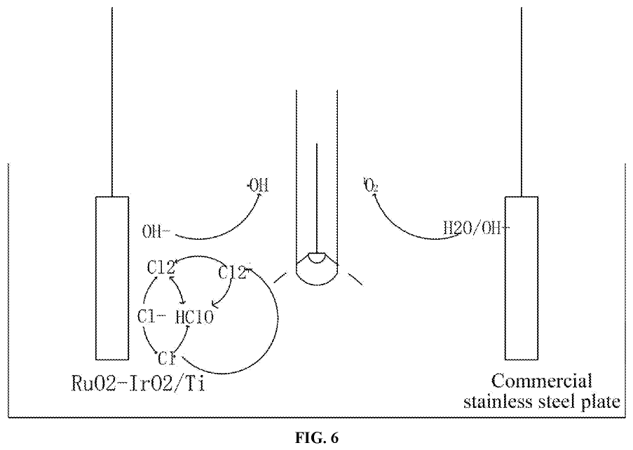

The photoelectrochemical device in FIG. 1 was used to purify seawater.

A specific process was as follows: The ultraviolet lamp assembly 3 was mounted on the first through hole 8 of the reactor top cover; the electrode assembly 2 was mounted on the second through hole 9; and the third through hole 10 was sealed with a sealing bolt. The reactor assembly 1 was arranged on the magnetic stirrer 21, and the rotor 20 was placed. The seawater to be treated was added into the reactor body, and the reactor top cover was closed. The speed was adjusted to make the rotor 20 rotate slowly at a uniform speed. The ventilation pipe 19 connected to the air blower 18 was led into the ultraviolet lamp assembly 3 to uniformly supply air. The rubber pipe 23 was connected to the circulating water bath inlet 7 and the circulating water bath outlet 7 on the outer sidewall of the reactor body. The circulating water pump 22 was turned on; a temperature was set; and preheating was carried out for 20 min before the reaction begins. The reactor body was wrapped with the tin foil to prevent the LED lamp from irradiating the human body and improve the light efficiency.

The 12V direct current power supply 15 was connected to the two electrode clamps 11 through the wires 14. The distance between the ruthenium iridium titanium electrode plate 12 and the stainless steel plate 13 was adjusted. The current density was set. After the temperature was controlled to be constant, the direct current power supply 15 and the LED lamp 16 were turned on for electrolysis and irradiation with the 285 nm ultraviolet light, so as to start the purification reaction.

The speed of the rotor was 400 rpm. The distance between the ruthenium iridium titanium electrode plate 12 and the stainless steel plate 13 was 3 cm. Each electrode had a size of 1×4 cm and a thickness of 1 mm. The current density was 1 mA/cm², and the temperature of the purification was 21±2° C.

Simulated seawater included: 20 μmol/L enrofloxacin, 24.53 g/L sodium chloride, and 2 mmol/L PBS buffer solution.

### Embodiment 2

The purification was carried out according to the method of Embodiment 1. The current density was adjusted to 2 mA/cm².

### Embodiment 3

The purification was carried out according to the method of Embodiment 1. The current density was adjusted to 5 mA/cm².

### Test Result

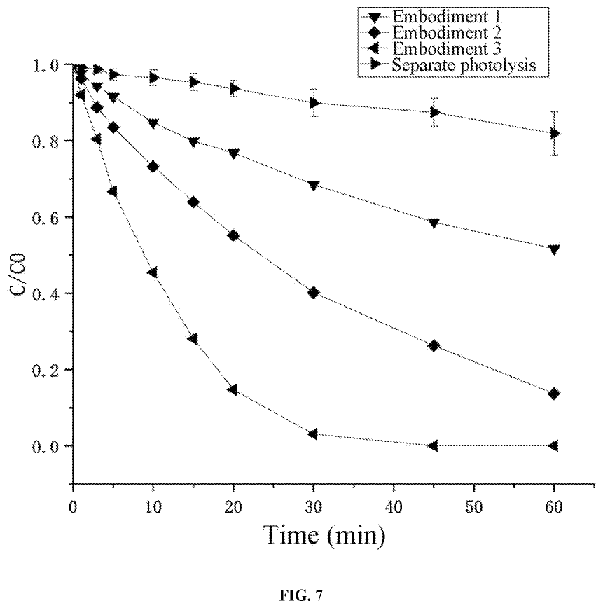

The test results were shown in FIG. 7 and Table 1 below:

TABLE 1
Degradation rates of enrofloxacin at different current densities

| | Separate | Embodiment | Embodiment | Embodiment |
|---|---|---|---|---|
| | photolysis | 1 | 2 | 3 |
| 0 | 100% | 100% | 100% | 100% |
| 1 min | 99% | 98% | 96% | 92% |
| 3 min | 99% | 94% | 89% | 80% |
| 5 min | 97% | 92% | 83% | 67% |
| 10 min | 97% | 85% | 73% | 45% |
| 15 min | 95% | 80% | 64% | 28% |
| 20 min | 94% | 77% | 55% | 15% |
| 30 min | 90% | 69% | 40% | 3% |
| 45 min | 87% | 59% | 26% | 0% |
| 60 min | 82% | 52% | 14% | 0% |

It can be seen from FIG. 7 and Table 1 that within a current density range of 1 to 5 mA/cm², photoelectric synergy can achieve quick degradation of the enrofloxacin compared to separate photolysis.

Although the above embodiments provide a detailed description of the present disclosure, they are only a part of the embodiments, not all the embodiments. Other embodiments can also be obtained without creativity according to this embodiment, and these embodiments all fall within the protection scope of the present disclosure.

What is claimed is:

1. A photoelectrochemical device, comprising a reactor assembly (1), an electrode assembly (2), and an ultraviolet lamp assembly (3), wherein
the reactor assembly (1) comprises a reactor body and a reactor top cover; and
the electrode assembly (2) and the ultraviolet lamp assembly (3) are fixed on the reactor top cover.

2. The photoelectrochemical device according to claim 1, wherein the reactor body is cylindrical double-layer glass; an outer sidewall of the reactor body is provided with a circulating water bath inlet (7) and a circulating water bath outlet (7);
the photoelectrochemical device further comprises a circulating water bath assembly (6); the circulating water bath assembly (6) comprises a circulating water pump (22) and rubber pipes (23); and
the circulating water pump (22) is connected to the circulating water bath inlet (7) and the circulating water bath outlet (7) through the rubber pipes (23).

3. The photoelectrochemical device according to claim 1, wherein the reactor top cover is made of polytetrachloroethylene; the reactor top cover is provided with a first through hole (8), a second through hole (9), and a third through hole (10);
the first through hole (8) is configured to fix the ultraviolet lamp assembly (3); the second through hole (9) is configured to fix the electrode assembly (2); and the third through hole (10) is configured for sampling and detection.

4. The photoelectrochemical device according to claim 1, wherein the electrode assembly (2) comprises PEEK electrode clamps (11), a ruthenium iridium titanium electrode sheet (12), a stainless steel plate (13), wires (14), and a direct current power supply (15); and
the ruthenium iridium titanium electrode sheet (12) and the stainless steel plate (13) are connected to the direct current power supply (15) through the PEEK electrode clamps (11) and the wires (14) in sequence, respectively.

5. The photoelectrochemical device according to claim 1, wherein the ultraviolet lamp assembly (3) comprises a light-emitting diode lamp (16) and a quartz glass protective lampshade (17).

6. The photoelectrochemical device according to claim 1, wherein the photoelectrochemical device further comprises a heat dissipation assembly (4); the heat dissipation assembly (4) comprises an air blower (18) and a ventilation pipe (19); and the ventilation pipe (19) is arranged in the quartz glass protective lampshade (17).

7. The photoelectrochemical device according to claim 1, wherein the photoelectrochemical device further comprises a magnetic stirring assembly (5); the magnetic stirring assembly (5) comprises a rotor (20) and a magnetic stirrer (21); and the reactor body is arranged on the magnetic stirrer (21).

8. A purification method for seawater implemented by the photoelectrochemical device according to claim 1, wherein the method comprises following steps:
feeding seawater to be purified into the reactor assembly (1), and purifying the seawater to be purified under a combined action of electrolysis and ultraviolet irradiation by the electrode assembly (2) and ultraviolet lamp assembly (3).

9. The purification method according to claim 8, wherein a distance between a ruthenium iridium titanium electrode sheet (12) and a stainless steel plate (13) in the electrode assembly (2) is 3 to 6 cm;
a voltage of the electrolysis is 2.46 to 2.69 V, and a current density is 1 to 5 mA/cm²; and
a wavelength of ultraviolet light used for the ultraviolet irradiation is 285 nm.

10. The purification method according to claim 8, wherein purification is carried out under a stirring condition, and a rotation speed of stirring is 400 rpm; and
a temperature of the purification is 15 to 30° C.

11. A purification method for seawater implemented by the photoelectrochemical device according to claim 2, wherein the method comprises following steps:
feeding seawater to be purified into the reactor assembly (1), and purifying the seawater to be purified under a combined action of electrolysis and ultraviolet irradiation by the electrode assembly (2) and ultraviolet lamp assembly (3).

12. A purification method for seawater implemented by the photoelectrochemical device according to claim 3, wherein the method comprises following steps:
feeding seawater to be purified into the reactor assembly (1), and purifying the seawater to be purified under a combined action of electrolysis and ultraviolet irradiation by the electrode assembly (2) and ultraviolet lamp assembly (3).

13. A purification method for seawater implemented by the photoelectrochemical device according to claim 4, wherein the method comprises following steps:
feeding seawater to be purified into the reactor assembly (1), and purifying the seawater to be purified under a combined action of electrolysis and ultraviolet irradiation by the electrode assembly (2) and ultraviolet lamp assembly (3).

14. A purification method for seawater implemented by the photoelectrochemical device according to claim 5, wherein the method comprises following steps:
feeding seawater to be purified into the reactor assembly (1), and purifying the seawater to be purified under a combined action of electrolysis and ultraviolet irradiation by the electrode assembly (2) and ultraviolet lamp assembly (3).

15. A purification method for seawater implemented by the photoelectrochemical device according to claim 6, wherein the method comprises following steps:
feeding seawater to be purified into the reactor assembly (1), and purifying the seawater to be purified under a combined action of electrolysis and ultraviolet irradiation by the electrode assembly (2) and ultraviolet lamp assembly (3).

16. A purification method for seawater implemented by the photoelectrochemical device according to claim 7, wherein the method comprises following steps:
feeding seawater to be purified into the reactor assembly (1), and purifying the seawater to be purified under a combined action of electrolysis and ultraviolet irradiation by the electrode assembly (2) and ultraviolet lamp assembly (3).

17. The purification method according to claim 11, wherein a distance between a ruthenium iridium titanium electrode sheet (12) and a stainless steel plate (13) in the electrode assembly (2) is 3 to 6 cm;
a voltage of the electrolysis is 2.46 to 2.69 V, and a current density is 1 to 5 mA/cm²; and
a wavelength of ultraviolet light used for the ultraviolet irradiation is 285 nm.

18. The purification method according to claim 11, wherein purification is carried out under a stirring condition, and a rotation speed of stirring is 400 rpm; and
a temperature of the purification is 15 to 30° C.

19. The purification method according to claim 12, wherein purification is carried out under a stirring condition, and a rotation speed of stirring is 400 rpm; and
a temperature of the purification is 15 to 30° C.

20. The purification method according to claim 13, wherein purification is carried out under a stirring condition, and a rotation speed of stirring is 400 rpm; and
a temperature of the purification is 15 to 30° C.
